(19) United States
(12) Patent Application Publication
(10) Pub. No.: US 2002/0046185 A1
(43) Pub. Date: Apr. 18, 2002

(54) System and method conducting POS transactions

(76) Inventors: Jean-Marc Villart, Paris (FR); Kevin Frank Ritschel, San Jose, CA (US); Nick Clark Epperson, San Ramon, CA (US); William Stuart Taylor, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/850,817

(22) Filed: May 8, 2001

Related U.S. Application Data
(60) Provisional application No. 60/229,275, filed on Aug. 30, 2000.

(51) Int. Cl. G06F 17/60

(52) U.S. Cl. 705/64

(57) ABSTRACT

A system and an apparatus that uses a wireless communications device to process payments through a server arrangement that is communicatively coupled with a data processing system located at a financial institution. In one embodiment, a server arrangement includes a processor and a memory arrangement, the memory arrangement including at least one of payment processing application that interfaces with the financial institution DPS. The server arrangement controls a plurality of data transmissions between the server arrangement and at least one EFTPOS terminal and includes at least one non-payment processing application that controls a set of functions of the EFTPOS terminal.

### RELATED PATENT DOCUMENTS

This application claims priority to U.S. Provisional Application Serial No. 60/229,275, filed on Aug. 30, 2000 (10004387-1), entitled “WAP POS.”

### FIELD OF THE INVENTION

The present invention generally relates to Point of Sale (POS) transactions, and more particularly to conducting POS transactions using a wireless communications network.

### BACKGROUND OF THE INVENTION

Automated teller machines and Electronic Funds Transfer Point of Sale (EFTPOS) terminals have operated for many years. Most current EFTPOS devices function in the same manner in that the account details are input into the device, along with an account type and P.I.N. (personal identification number), and the information is sent to a bank or financial institution for authorization. Once authorization is received the transaction continues until completion, for example, by cash received or receipt of article purchased and receipt tendered.

In a retail scenario, a customer typically finishes shopping and takes all of the goods to be purchased to a clerk or cashier at a checkout line that includes a cash register. Once all of the goods have been logged into the system for payment, the customer typically tenders payment via a charge card or credit card. A POS device owned by the merchant is positioned adjacent the cash register and is used to process payment based on the account information on the card. Account information, that includes the credit card account number, is processed once an authorization code is inputted into the system. The data is sent via a dial up modem system through leased lines that have a permanent connection to a transaction switching network where it is sent through the customer's bank's host computer to obtain bank authorization. The merchant's bank is also involved in the processing system in order to coordinate the transfer of funds from the customer's bank to the merchant's bank.

Most of the purchase transactions today that utilize the EFTPOS system are limited to merchants having fixed in-store (or facility) installations. This is, however, costly infrastructure and fixes the location of the merchant POS device. Any movement of a POS device from one location to another will have an accompanying telephone line installation. Another payment system approach utilizes authorization by telephone where the merchant actually calls into the customer's credit card company for real-time authorization of the transaction. Unfortunately, this approach is not only time consuming but does not provide a single receipt with most of the purchase and account details conveniently displayed.

New communications systems and protocols are being developed and promoted by major consortiums in an effort to harness the power of the Internet to streamline business processes. However, the differences in communications standards, software and hardware have made it difficult for payment transaction system developers to design a system that will not quickly become obsolete or be too cumbersome to use as soon as the system is commercially available.

A method and a system that address the aforementioned problems, as well as other related problems, are therefore desirable.

### SUMMARY OF THE INVENTION

The present invention is directed to addressing the above and other needs in connection with conducting POS related transactions while providing mobility and lower initial investments in merchant POS payment systems.

According to one aspect of the invention, using a WAP (wireless application protocol) as a messaging format for a POS device provides an open system that is easily optimized to send credit-card based messages to small-screened devices, such as cellular telephones and personal digital assistants (PDAs). In addition, a WAP enabled appliance is now communicatively coupled to a WAP based server via a WAP based network, thereby providing merchant desired but previously inaccessible applications to the WAP enabled appliance.

According to another aspect of the invention, an apparatus is incorporated into an electronic funds transfer point of sale (EFTPOS) system that facilitates reconfiguration of the system without altering any of the hardware or any of the EFTPOS terminals. The EFTPOS system includes a data processing system (DPS) located at a financial institution. The apparatus is a server arrangement that includes a processor and a memory arrangement, the memory arrangement including at least one of payment processing application that interfaces with the financial institution DPS. The server arrangement controls a plurality of data transmissions between the server arrangement and at least one EFTPOS terminal and includes at least one non-payment processing application that controls a set of functions of the EFTPOS terminal.

According to yet another aspect of the invention, a wireless application protocol (WAP)-enabled point-of-sale device includes a WAP enabled appliance having a housing for an integrated display, a data entry device and a communications unit. The communications unit includes a communications processor arrangement and a card reading interface configured and arranged to receive customer-specific financial account data from a customer identification card. The processor arrangement is configured and arranged to transmit and receive from a data processing system (DPS) integrity verification of a sales transaction using the customer-specific financial account data.

According to yet another aspect of the invention, a method of using a wireless application protocol (WAP) device by a sales person to transmit a customer's financial data to a remote DPS, wherein the WAP device includes a WAP enabled communications appliance having a data display and data input device that is used for processing WAP based data communications. Upon receipt of customer-specific financial account data from a customer identification card, a payment authorization request is transmitted pursuant to a purchase order via the WAP enabled communications appliance to a WAP enabled DPS using the customer-specific financial account data. The WAP enabled communications appliance receives a payment authorization status for the purchase order via the WAP enabled DPS that uses the customer-specific financial account data for determining payment authorization status.

It will be appreciated that various other embodiments are set forth in the Detailed Description and Claims that follow.

### BRIEF DESCRIPTION OF THE DRAWINGS

Various aspects and advantages of the invention will become apparent upon review of the following detailed description and upon reference to the drawings in which:

FIG. 1 is a diagram of a POS transaction system that incorporates a proxy server in accordance with an example embodiment of the invention;

FIG. 2 is a diagram of another wireless application protocol based POS transaction system in accordance with another example embodiment of the invention;

FIG. 3 is a diagram of another wireless application protocol based POS transaction system including a WAP enabled device in accordance with another example embodiment of the invention; and

FIG. 4 is a diagram of yet another wireless application protocol based POS transaction system including a WAP enabled device in accordance with another example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described in connection with wireless application protocol (WAP) enabled devices that facilitate mobility and lower infrastructure costs of implementing POS transaction systems. Those skilled in the art will appreciate that the invention could be implemented in a variety of programming languages and hardware platforms.

In an example embodiment, a wireless application protocol (WAP) enabled POS transaction system simplifies payment processing for a system that includes a payment processing WAP enabled DPS coupled to a wireless application protocol communications network. The system includes a WAP enabled communications appliance having a data display and a data input device for processing WAP based data communications. An interface configured and arranged to receive customer-specific financial account data from a customer identification card is coupled to the WAP enabled communications appliance. The WAP enabled communications appliance is also configured and arranged to transmit and receive from the payment processing DPS via the WAP communications network integrity verification of a sales transaction using the customer-specific financial account data. A payment authorizing DPS is adapted to use the customer-specific account data received from the payment processing DPS for verifying payment ability of the customer and is adapted to send payment ability verification to the WAP enabled communications appliance via the WAP based communications network.

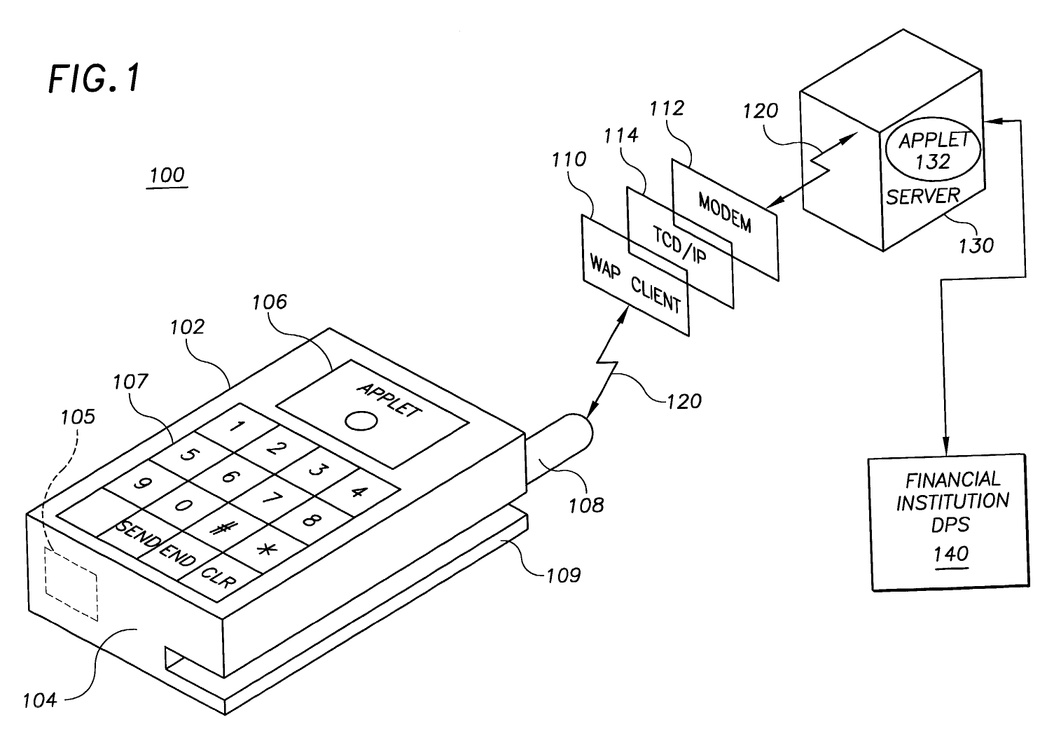

Referring now to the figures, FIG. 1 illustrates a POS transaction system 100 that incorporates a proxy server 130 in accordance with an example embodiment of the invention. POS appliance or device 102 is configured to read a credit card (or a smart card or a chip card) and to transmit and receive customer-specific financial account data that is tendered in connection with authorizing payment in a sales transaction. In one embodiment, POS device 102 is a thin client POS that does not include memory or a microprocessor. Device 102 would simply relay data immediately to server 130 that includes an applet 132 (such as a payment processing application) for processing data received from device 102. In this example, server 130 includes a microprocessor and memory to perform the data transfer and processing functions between the server and the POS device. POS device 102 includes browsing capability, powered by server 130, to facilitate I-mode; web clipping and WML based communication.

A communication link 120 between device 102 and server 130 could be wireless (wireless WAN or cellular), via a communications network (e.g., modem to PSTN or LAN) or could be a direct connection. Device 102 includes a housing 104, a display 106, a keypad 107 (or touchscreen), an antenna 108 and a card reader 109 (double or triple track reader). In a related embodiment, card reader 109 is a magnetic stripe reader that is adapted to read data from the magnetic stripe located on most credit or charge cards. In another embodiment, card reader 109 includes a slot for reading smart cards that have integrated chips located thereon. A printer (impact or thermal) could be coupled to device 102 that would be controlled by server 130.

In this example embodiment, appliance 102 does not include a processing unit, such as a processor, for processing software applications nor does it include memory. Appliance 102 operates as a simple interface for receiving and transmitting data to the server. Appliance 102 immediately transmits customer account information to server 130. An application (such as applet 132) within server 130 is initialized and then server 130 takes control of the processing of the customer account information provided by card reader 109. Server 130 also takes control of the interactions between appliance 102 and server 130. Server 130 sends commands to appliance 102 to display data, to send data to a PIN PAD display (not shown), send data to a printer or send data to the chipcard. Data includes payment amount, retail location, personal identification numbers or messages that may need to be sent to DPS 140. Transactions are executed on the server side of communications link 120. Client 110, in this example, operates with the operating system of appliance 102 (and as a slave to server 130) to interpret any commands and data sent from server 130. Where server 130 requests that a prompt be displayed or wants the customer to enter an amount, client 110 waits for the amount to be entered on keypad 107 and then sends the information back to server 130, thereby acting as a basic interpreter. The data is then received and displayed on display 106 or is sent to a printer or chipcard.

In another embodiment, device (or appliance) 102 includes processing and memory capabilities as well as an integrated modem and client software. In a related embodiment, device 102 is a FAT POS incorporating multiple applications that operate within device 102. POS device 102 includes a processor arrangement 105 adapted to transmit and receive from a DPS (data processing system) integrity verification of a sales transaction using the customer account data. In this example, server 130 and device 102 share processing duties. POS appliance 102 is configurable to include application software, in the form of applets, for operating in a WAP environment. Device 102 is communicatively coupled with a WAP client 110 that interprets commands received from server 130. WAP client l is shown outside of WAP appliance 102 for illustration purposes only. These additional elements provide device 102 with the ability to access the network or the Internet directly and to communicate with server applications via the client interpreter of the client software.

In this example embodiment, a WAP communications link 120 is facilitated by a dial-up modem 112 using TCP/IP protocol 114 for coupling WAP appliance 102 with a WAP-enabled server 130. In a WAP-enabled system, a WAP server gives the WAP device access to the protocols that are similar to lower level protocols provided by a normal Internet Service Provider (ISP). These protocols are used to access either a private WAP gateway, hosted by a mobile operator, or a public WAP gateway, which moves the gateway out of the Internet and is hosted on the public service telephone system. The WAP gateway is the link between the wireless device and the Internet, thereby giving the WAP device access to the Internet. A WAP server, such as WAP POS server 130, is included in the system where the merchant is looking to control the stream of data sent between the web server and WAP appliance 102. WAP appliance 102 uses a WAP browser, similar to an Internet browser, which is referred to as a web interpreter or a web client. The WAP browser operates using a wireless markup language (WML) interpreter that is the wireless counterpart to the HTML interpreter used in Internet browsers. Due to the small screens utilized by hand-held devices (2-8 lines), WAP browsers allows interpretation of WML pages in the same way as the Internet browser interprets the HTML pages from the web server.

In this example embodiment, WAP appliance 102 is a small, merchant counter top device that is coupled to modem 112. Modem 112 couples appliance 102 with WAP server 130 via communications link 120, thereby forming a transparent communications link between appliance 102 and server 130. In this configuration, appliance 102 performs minimal processing tasks while leaving the majority of the processing tasks to be conducted by WAP server 130. Credit card information that is received through card reader 109 is transmitted through link 120 directly to WAP server 130 for authorization of payment, processing of payment and processing a credit verification. This approach provides the advantage of using one WAP server to service a plurality of WAP appliances similar to appliance 102. In contrast with other POS systems requiring that all devices connected to the POS system be updated when new applications are available, only WAP server 130 need be updated when new software is developed.

In an example application, a clerk or cashier uses WAP POS device 102 in a retailing location as he is performing customer service duties in the store. Once a customer has completed his shopping, the customer tenders selected goods to the cashier for logging of the purchases into a merchant purchasing system (not shown). In a related application, the WAP POS device is used to check or log in purchases where the customer has only one or two items. The purchases are logged into the POS device using the keypad or a barcode reading device coupled to the POS device. Once all the goods have been logged into the system, the customer proceeds to pay with a store charge card or a bank issued credit card. Appliance 102 is on standby mode and is activated when the credit card is swiped or slid across card reader 109, thereby initiating a connection with server 130 via modem 112. The card reader 109 receives (and subsequently transmits) customer-specific account information, which in this case corresponds to at least the credit card account number and, optionally, the issuing bank identification number. Magnetic card reader 109 has a corresponding magnetic stripe that couples with the magnetic card stripe on the card for reading the account information.

Applet 132 within WAP POS server 130 is an example of a payment application being run by server 130 using appliance 102 as a user interface. Most applications are run on server 130 but the results of the applications are displayed on appliance display 106. Graphics and text of applications run in server 130 are displayed to the user or merchant via display 106. Running payment transactions and data transmissions are transparent to the customer. WAP POS server 130 sends the completed transactions back to appliance 102 via communications link 120 (which can be via a cable system or via a wireless system). In this example, communication link 120 is a combination of hardware and software layers that facilitate communication between appliance 102 and server 130. In a related embodiment, server 130 is remotely reconfigurable, allowing applications to be changed or updated, where server 130 is connected to the Internet or another WAP network. Applications are easily updated without having to change the hardware configuration of the WAP network or appliance locations used as payment terminals. Since most of the processing power and memory resides on server 130, new WAP applications are easily added to the system. WAP protocols are currently being developed for wireless phones that provide the capability of taking web content and displaying the information on very small screens (such as on a cellular telephone or a personal digital assistant).

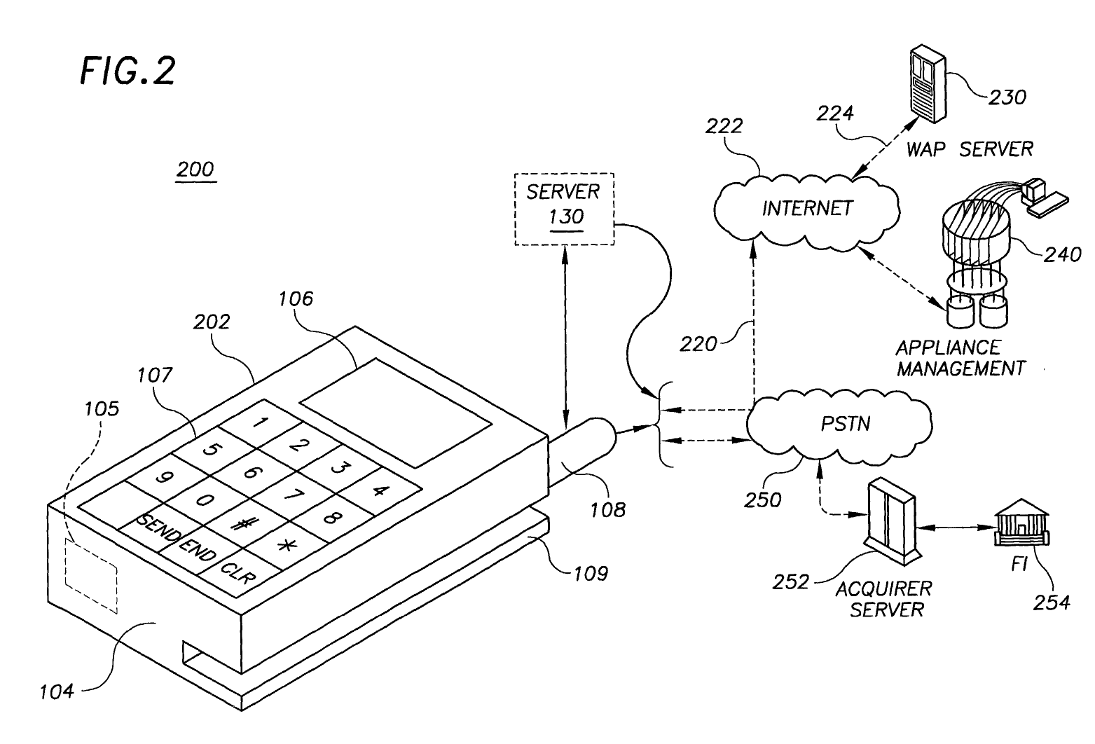

A POS transaction system typically supports about 2 applications, which include processing payments and sending messages to a bank. However, a merchant usually needs more applications directed to, but not limited to, credit card application processing, check authorization and micro payments. Referring now to FIG. 2, a wireless application protocol based POS transaction system 200, according to another example embodiment of the invention, illustrates a system for providing additional applications to the merchant. System 200 includes a WAP POS appliance 202 that is a conventional POS device that has been modified, according to the present invention, to access a WAP server through the Internet. In this manner, the merchant has access to the additional applications needed in addition to the applications available from the hardwire connection through a PSTN (Public Service Telephone Network). Thus, WAP appliance 202 includes many of the elements of a conventional POS device (keypad, display, card reader, communications connection, etc.), however a modem (not shown) accesses a WAP server 230 via a WAP network 220, through the Internet 222 and via a communications link 224. Several appliances in the system are managed from appliance 202 through Internet 222 via appliance management 240. The currently available applications for the merchant are accessed through PSTN 250 and an acquirer server 252 in conjunction with a DPS at a financial institution 254. This embodiment uses the WAP enable network and protocol to provide value added applications and appliance system management while providing the capability of conducting payment transactions using traditional routes or WAP servers such as Thin/WAP POS server 130.

In this example, WAP POS appliance 202 is similar to a conventional POS device in that it is programmable and has sufficient memory to run various payment applications on site. Appliance 202 includes a WAP client/interpreter that is treated as one of the payment applications but provides interpretation of WAP information coming from WAP server 130. Appliance 202 has the additional benefit of leveraging off server 130 for additional applications (e.g., micro-payment, CHIP COM, royalty, credit applications and check authorization), via the Internet 222 connection, and processing power that conventional POS systems do not have.

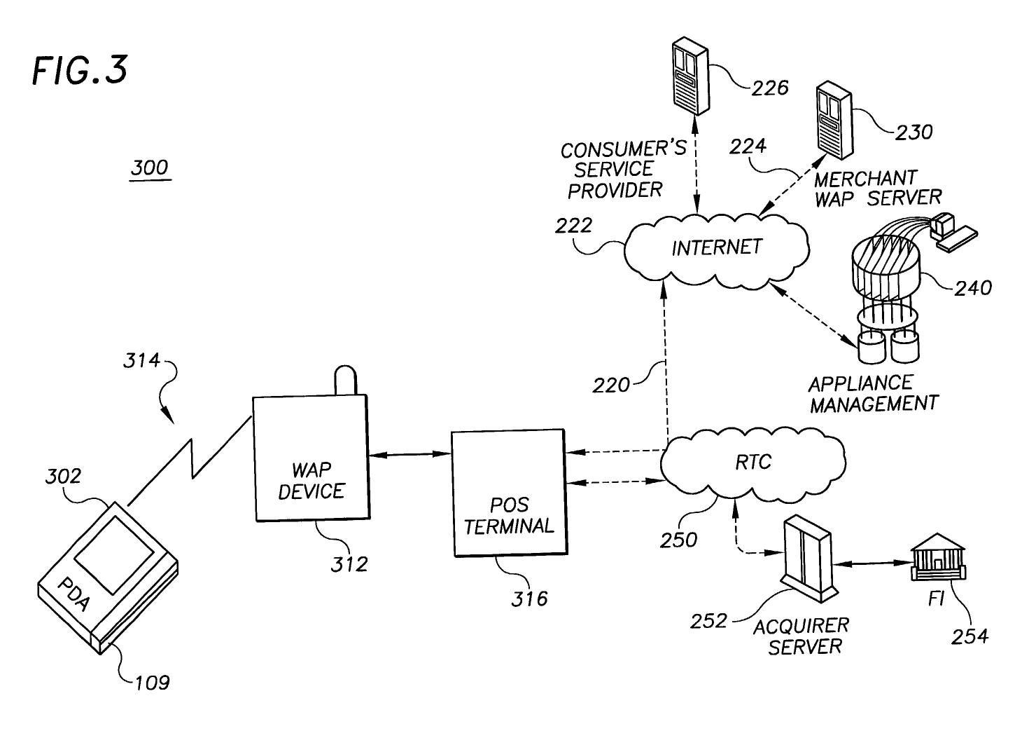

Referring now to FIG. 3, in a system similar to FIG. 2 an example embodiment of a WAP-enabled POS transaction system 300 facilitates point and pay POS transactions systems for merchants. Wireless points of interaction with a POS system would provide merchants with the capability of synchronizing WAP based appliances with the Internet. Equipment or appliances that conduct such interactions are those that communicate with the POS system with infrared and short-range radio frequency transmissions (e.g., Bluetooth TM) via intermediate receiving equipment that are coupled to the POS system. System 300 includes a hand-held WAP appliance 302 that is adapted to be communicatively coupled to a second WAP device 312 via an RF or infrared signal 314. In an example embodiment, second WAP device 312 is coupled to a dial-up modem that is in turn coupled through a network connection to a dial-in server for access to a merchant WAP server. However, in this embodiment, device 312 is coupled to an intermediate POS device 316 (similar to device 202 of FIG. 1) that is coupled to a modem for eventual connection to WAP server 230. Once on the Internet 222, a consumer's service provider gateway 226 is also accessible. In this example, WAP appliance is a hand-held personal digital assistant (PDA) that is used to synchronize with another PDA coupled to consumer's service provider gateway 226. In another application, the WAP appliance is a mobile type telephone or a small portable notebook that has short range wireless communication capabilities.

In a related embodiment, the WAP enabled mobile phone is capable of interacting with an Bluetooth-enabled wireless wallet having a smart card/credit card therein. Using the WAP phone allows the customer to pay for his purchases without removing the wallet from his pocket. The Bluetooth protocol uses radio transmission technology to communicate with a smart card reader in the wallet. When a smart card is inserted into the wallet, it can communicate with the Bluetooth-enabled mobile phone. From the WAP mobile phone the transaction data is sent via an RF signal to a WAP-Gateway which then re-transmits the data to the WAP-Server. The WAP-Server transmits the data via a WAP network, the Internet or a cellular or public telephone service network to establish the connection with an authorizing DPS located at the financial institution.

Once the communications link 220 is established with the WAP network, various applications are accessible to the consumer, as well as the merchant, via the network established by the merchant. In one application, a customer that is looking to make reservations with a major hotel chain is able to access the reservation system, through the hotel's WAP enabled network, and make a reservation request while accessing the Internet for personal use, using a single hand-held appliance 302.

In a related application, the WAP enabled POS device is used by a sales person to conduct sales transactions in locations remote from the store or warehouse or is used by a mobile merchant that transports his goods as part of the service provided. POS device 302, or second WAP device 312, includes logic and software that provides the capability of simulating an EFTPOS terminal by using the display of device 302 and connectivity of WAP technology to communicate back to server 230, via device 312. Server 230, in turn, communicates with a DPS at an authorizing bank from a remote location and displays the result of the authorization and sales transaction to the customer via a return communication back to WAP POS device 302. Such a capability will enable home service providers and delivery people to secure payment immediately, thereby reducing paperwork and eliminating collection issues.

In another related embodiment, sales calls are turned into immediate purchase orders and actual paid sales since a sale is consummated while the customer is still on the phone. WAP enabled POS device 302, which in this case is a mobile cellular telephone with WAP network accessing capabilities, is used to call a customer from a remote location where a sales person is traveling and is away from the office. Upon reaching an agreement with the customer on a particular order, the sales person simply inputs the account information via the keypad (by implementing an alternate function key to avoid call termination) and sends the transaction data via the WAP network and Internet to a DPS at a financial institution for authorization. Issues of security of the actual transaction data can be managed by placing a hold on customer funds for a predetermined period of time, such as 24 hours, to allow the customer time to review the transaction to ensure the funds were taken out properly. In addition, the transaction is subject to certain monetary limits and/or limited to personnel authorized to make such contractual commitments as examples of improving security in these transactions.

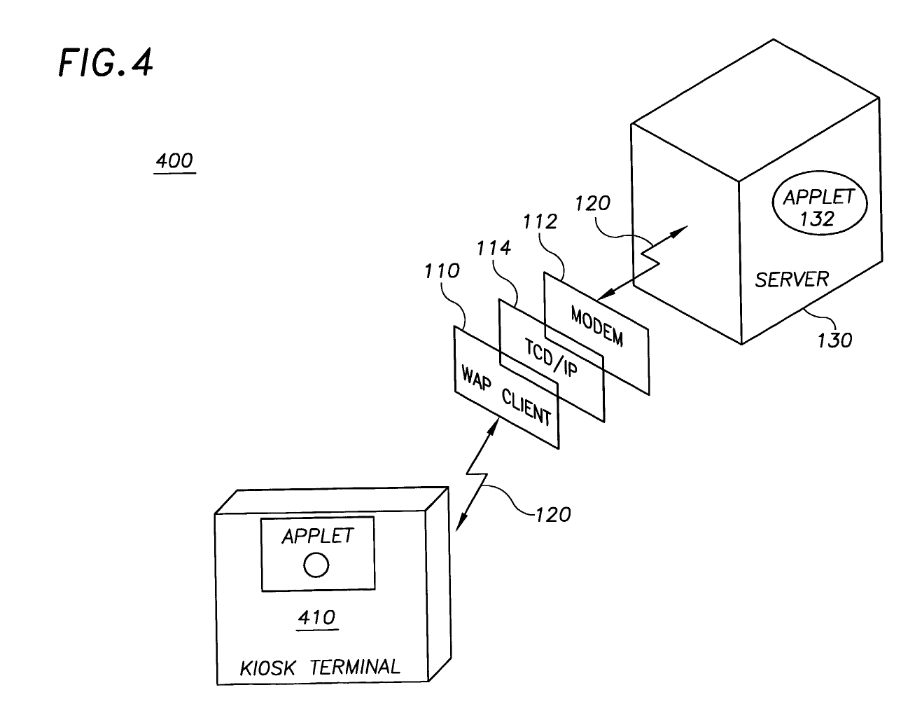

Other applications of WAP POS systems include WAP vending machines or kiosks that are located in an apartment or a shopping center, respectively. Referring now to FIG. 4, a WAP based POS transaction system 400, similar to system 100 described above, provides WAP enabled POS transaction capabilities where there is a larger user interface. In particular, a kiosk device or vending machine 410 is coupled to WAP server 130 via modem 112 and communications link 120 to provide the capability of processing purchasing transactions. Touch screens or large screen capabilities of these devices enhance the WAP client/interpreter software capabilities for the user. Additional applications can also be performed, such as credit application approvals and check authorizations due to the accessibility provided by the WAP network and the WAP server. In other applications, similar capabilities are integrated in taxicabs or in personal digital assistants that are WAP enabled that have different screens and keying features. Next generation countertops for kitchens and restaurants will easily integrate the teachings of the present invention.

Various embodiments of the invention are believed to be applicable to a variety of POS payment authorization and transaction systems. In addition, the WAP enabled system of the present invention is applicable to “FAT” POS systems. It is also envisioned that the WAP protocol be incorporated into “Thin POS” systems that support such architecture. The present invention has been found to be particularly applicable and beneficial in scenarios involving POS transactions that are conducted in the customer's presence. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A point of sale (POS) transaction system comprising:
at least one point of sale (POS) device adapted to transmit a set of customer financial account data, the POS device adapted to receive a payment processing status in response to the transmission of the customer financial account data; and
a server arrangement configured and arranged to execute a payment processing application in response to the set of customer financial account data received from the POS device, the server arrangement configured to send the payment processing status after executing the payment processing application to the at least one POS device.

2. An apparatus for use in an electronic funds transfer point of sale (EFTPOS) system, the system including at least one EFTPOS terminal and a data processing system (DPS) located at a financial institution, the apparatus comprising:
a server arrangement including a processor and a memory arrangement, the memory arrangement including at least one of payment processing application that interfaces with the financial institution DPS, the server arrangement configured and arranged to control a plurality of data transmissions between the server arrangement and the at least one EFTPOS terminal, wherein the server arrangement includes at least one non-payment processing application that controls a set of functions of the EFTPOS terminal.

3. The apparatus of claim 2, wherein the server arrangement is also adapted to control the plurality of data transmissions with a display, a printer and a card reading device of the at least one EFTPOS terminal.

4. The apparatus of claim 2, further comprising a plurality of EFTPOS terminals coupled to the server arrangement, the server arrangement is adapted to control the plurality of data transmissions between the terminals and the server arrangement.

5. A wireless-application-protocol enabled point-of-sale device, the device comprising:
a wireless-application-protocol enabled appliance including a housing for an integrated display, data entry means and communications unit, the communications unit including a communications processor arrangement and a card reading interface configured and arranged to receive customer-specific financial account data from a customer identification card, the processor arrangement configured and arranged to transmit and receive from a'DPS integrity verification of a sales transaction using the customer-specific financial account data.

6. The device of claim 5, wherein the communications unit further includes an application specific circuit arrangement coupled to the card reading interface and adapted to transmit customer-specific financial account data from the card reading interface to the CPU.

7. The device of claim 5, wherein the appliance includes a wireless application protocol enabled mobile telephone configured and arranged to communicate with a wireless application protocol DPS.

8. The device of claim 5, further comprising a memory arrangement having a program stored therein, when executed, causes the processor arrangement to transmit and receive from a CPU integrity verification of a sales transaction using the customer-specific financial account data.

9. The device of claim 8, wherein the card reading interface includes a magnetic stripe reading device and a strip slot adapted to guide the identification card while the magnetic stripe is being read, and wherein the processor arrangement further includes an application specific circuit arrangement configured and arranged to receive financial account data from the customer via the magnetic stripe reading device and adapted to receive data back from a CPU, the processor arrangement communicatively coupled with a wireless application protocol data processing circuit,

10. A method of using a wire less application protocol device to transmit financial data to a DPS, the method comprising:
using WAP enabled communications means including means for displaying and inputting data for processing WAP based data communications; and
receiving customer-specific financial account data from a customer identification card and transmitting to and receiving from the DPS via WAP enabled communications means integrity verification of a sales transaction using the customer-specific financial account data.

11. The method of claim 10, wherein the step of receiving customer-specific financial account data includes transmitting customer-specific financial account data via an application specific circuit arrangement coupled to the communications means.

12. The method of claim 10, wherein the step of receiving customer-specific financial account data includes the steps of:
reading a magnetic stripe from the customer identification card; and
guiding the customer identification card as the magnetic stripe is being read.

13. The method of claim 10, after the step of transmitting and receiving customer account data, further including the step of reconfiguring the DPS, wherein the DPS is WAP enabled and coupled to a WAP enabled network.

14. A method of using a wireless application protocol device in a point of sales transaction between a sales person and a customer, the method comprising:
using WAP enabled communications means including means for displaying and inputting data for processing WAP based data communications;
receiving customer-specific financial account data from a customer identification card and transmitting a payment authorization request pursuant to a purchase order via the WAP enabled communications means to a WAP enabled DPS using the customer-specific financial account data; and
receiving via the WAP enabled communications means a payment authorization status for the purchase order via the WAP enabled DPS that uses the customer-specific financial account data for determining payment authorization status.

15. The method of claim 14, before the step of receiving customer-specific account data, including the step of logging a set of purchases by the customer in a retail location.

16. The method of claim 14, where the step of receiving customer-specific account data includes the step of initiating a communication link with the WAP enabled DPS upon receiving the customer account data and before transmitting the customer account data to the DPS.

17. A wireless application protocol (WAP) enabled POS transaction system including a payment processing WAP enabled DPS and a wireless application protocol communications network, the system comprising:
WAP enabled communications means including means for displaying and inputting data for processing WAP based data communications;
means for receiving customer-specific financial account data from a customer identification card coupled to the WAP enabled communications means, the WAP enabled communications means also for transmitting and receiving from the payment processing DPS via the WAP communications network integrity verification of a sales transaction using the customer-specific financial account data; and
a payment authorizing DPS adapted to use the customer-specific account data received from the payment processing DPS for verifying payment ability of the customer and sending payment ability verification to the WAP enabled communications means via the WAP based network.

18. The system of claim 17, further comprising a customer service provider server that is accessible with the WAP enabled communications means while the communications means is coupled to the payment processing DPS.

19. The system of claim 17, wherein means for receiving customer-specific account data includes a magnetic stripe reader adapted to read customer-specific account data from the customer identification card.

20. The system of claim 19, wherein means for receiving customer financial account data includes an application specific circuit arrangement coupled to the magnetic stripe reader and configured and arranged to transmit the customer account data from the stripe reader to the WAP enabled communications means.
